(19) United States
(12) Patent Application Publication
(10) Pub. No.: US 2026/0300352 A1
(43) Pub. Date: Oct. 1, 2026

(54) AUTOMATIC DATA STITCHING BETWEEN A SEMANTIC MODEL AND PHYSICAL DATA

(71) Applicant: Collibra Belgium BV, Brussels (BE)

(72) Inventors: Gretel De Paepe, Watermaal-Bosvoorde (BE); Peter Princen, Brussels (BE); Eric C. Warner, Sandwich, MA (US)

(21) Appl. No.: 19/197,698

(22) Filed: May 2, 2025

Related U.S. Application Data
(60) Provisional application No. 63/779,636, filed on Mar. 28, 2025.

(51) Int. Cl. G06F 16/334; G06F 40/30

(52) U.S. Cl. CPC G06F 16/3347; G06F 40/30

(57) ABSTRACT

The system obtains metadata associated with physical data and metadata associated with a semantic model and converts the metadata associated with the physical data into a first embedding vector and the metadata associated with the semantic model into a second embedding vector. The system determines a measure of similarity between the first embedding vector and the second embedding vector in the multidimensional space, and obtains a threshold associated with the measure of similarity. The system compares the measure of similarity with the threshold to determine whether to create a mapping between the physical data and the category associated with the semantic model. Based on the comparison, the system creates the mapping between the physical data and the category.

### CROSS-REFERENCE TO RELATED APPLICATIONS

This application claims benefit of and priority to U.S. Provisional Patent Application No. 63/779,636 filed on Mar. 28, 2025, and titled AUTOMATIC DATA STITCHING BETWEEN A SEMANTIC MODEL AND PHYSICAL DATA, which is incorporated herein by reference in its entirety.

### BACKGROUND

Semantic models define what data represents, while physical data describes how the data is stored. Without a connection between these two perspectives, the meaning of data can be obscured by its technical implementation.

### BRIEF DESCRIPTION OF THE DRAWINGS

Detailed descriptions of implementations of the present invention will be described and explained through the use of the accompanying drawings.

FIG. 1 shows a system to map physical data to a semantic model.

FIG. 2 shows a semantic model.

FIG. 3 shows a hierarchical visualization of semantic model categories.

FIG. 4 shows the mapping between a category in the semantic model and physical data.

FIG. 5 shows metadata associated with the physical data.

FIG. 6 shows selection of metadata to provide to the large language model (LLM).

FIG. 7 shows suggested mapping of physical data to categories in the semantic model.

FIG. 8 is a flowchart of a method to create a mapping between physical data and a category in a semantic model.

FIG. 9 is a block diagram of an example transformer.

FIG. 10 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Semantic models represent requirements and structures (the “what”), while physical data reflects technical implementation (the “how”). Without a link between them, the semantic context can be lost when relying solely on physical details. Data stitching bridges this gap, linking semantic definitions to their physical sources. This connection unlocks richer data understanding, enables lineage tracking, and facilitates more effective data management.

The disclosed system obtains metadata associated with physical data and metadata associated with a semantic model. The metadata associated with physical data indicates a description associated with the physical data and/or accepted classifications associated with the physical data. The accepted classifications associated with the physical data can be already established mappings between the semantic model and a column with the same name as the current column in the physical data. The metadata associated with the semantic model can include a description associated with a category in the semantic model and can also include the name of the category.

The system converts the metadata associated with the physical data into embedding vector A, and the metadata associated with the semantic model into embedding vector B, where the embedding vectors A and B are numerical vector A and B, respectively, in a multidimensional space. The system determines a measure of similarity, such as cosine similarity, between the embedding vector A and the embedding vector B in the multidimensional space and obtains a threshold associated with the measure of similarity.

The system compares the measure of similarity with the threshold to determine whether to present the measure of similarity to a user. Upon determining to present the similarity score, the system presents a suggested mapping to a user, a user interface element allowing acceptance of the suggested mapping, and a user interface element allowing rejection of the suggested mapping. The suggested mapping includes an indication of the physical data associated with the embedding vector A and an indication of the category in the semantic model associated with the embedding vector B. Upon receiving a selection of the user interface element allowing acceptance of the suggested mapping, the system maps the physical data to the category in the semantic model.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Automatic Data Stitching Between the Semantic Model and Physical Data

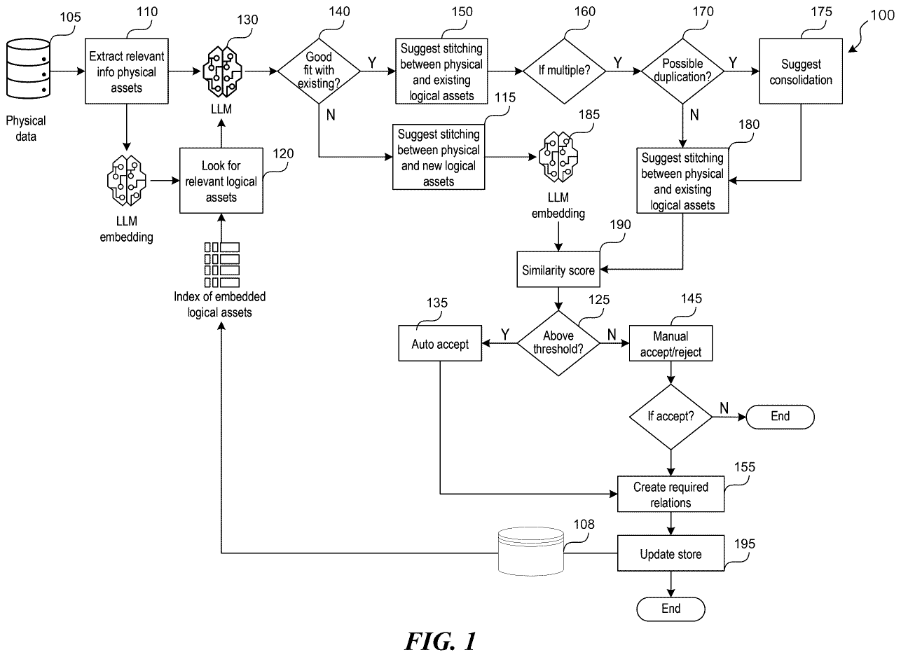

FIG. 1 shows a system to map physical data to a semantic model. The system 100 uses artificial intelligence (AI), such as large language models (LLMs), natural language processing (NLP), and/or clustering techniques to facilitate automatic data stitching, e.g., mapping, connecting physical data assets to the semantic model, e.g. the semantic assets, as described in this application.

The system 100 in step 110 extracts relevant information from physical data 105. The relevant information can include metadata. In step 120, the system 100 obtains relevant information from the semantic model, such as the metadata from the semantic model. The semantic model can include one or more categories, as described in this application. Previous results of operating the system 100, such as the previous mappings, can be stored with the semantic model, and these outputs can be included in the subsequent operations of the system. The previous mappings can include data classification features and/or data similarity features. Data classification features can describe how certain physical data maps to certain categories in the semantic model, while data similarity features indicate similarity between the physical data and a semantic category.

In step 120, the system 100 can obtain relevant categories from the semantic model, prioritizing those categories already associated with physical data similar to the physical data under consideration currently, or those within the relevant domains. The system in step 120 can filter based on data type compatibility to ensure realistic stitching options. For example, if data type associated with a category, e.g., class, in the semantic model is known to be incompatible with the data type associated with the physical data 105, the system 100 does not retrieve the incompatible category from the semantic model in step 120.

The LLM 130 includes specialized logic for analyzing metadata and generating highly relevant mapping, e.g., stitching, suggestions linking physical assets to appropriate semantic assets. As described below, the LLM 130 can consider output of data similarity features in order to ensure similar physical assets are linked to corresponding semantic assets.

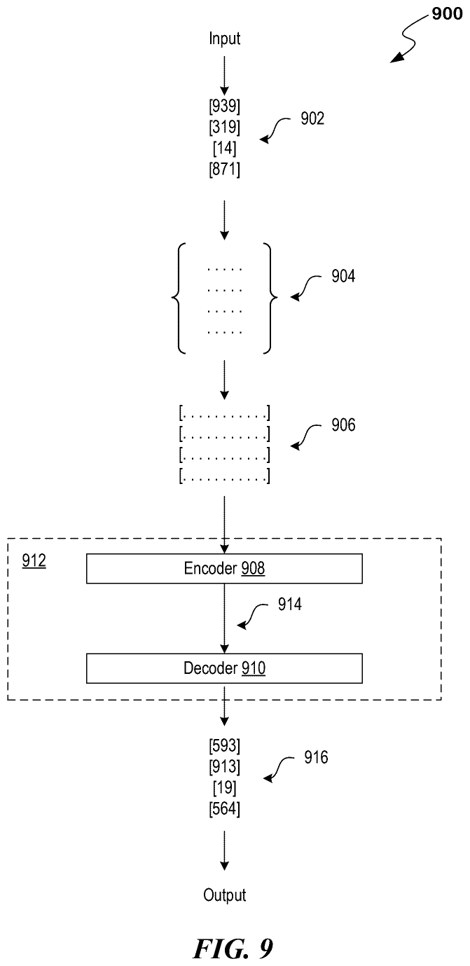

The LLM 130 can intelligently extract semantic meaning from the relevant information, e.g., metadata, associated with the physical data and the semantic model and obtained in steps 110, 120, respectively. The LLM 130 can represent metadata, such as names and descriptions, in both the physical data and the semantic model using embedding vectors as described in FIG. 9 of the specification. The LLM 130 can identify the semantic intent of both physical and semantic data elements by considering the context: breadcrumbs, descriptions, location in the knowledge graph (e.g., column is part of table, is part of schema, etc). A breadcrumb trail on a page indicates the page's position in the site hierarchy and can help users understand and explore a site effectively. A user can navigate all the way up in the site hierarchy, one level at a time, by starting from the last breadcrumb in the breadcrumb trail.

In addition, the LLM 130 can consider mapping between the physical data and the semantic model obtained from previous operations of the system 100. Further, the LLM 130 can consider data similarity between the physical assets under consideration presently and a physical asset that has been previously mapped to the semantic model.

The LLM 130 scores each candidate target, e.g., each category in the semantic model, based on semantic relevance. This creates a confidence stitching score, which indicates the likelihood that the mapping between the physical data under consideration and the category in the semantic model is correct.

To determine the confidence stitching score, the LLM 130 can represent the metadata obtained from both the physical data and the semantic model as embedding vectors and can measure the similarity between the embedding vectors.

Measuring the similarity between two embedding vectors is a fundamental task in various machine learning and NLP applications. There are several methods to quantify this similarity, with the most popular ones being cosine similarity, Euclidean distance, and dot product. Cosine similarity measures the cosine of the angle between two vectors, focusing on their orientation rather than their magnitude. It is calculated by taking the dot product of the vectors and dividing it by the product of their magnitudes. Euclidean distance, on the other hand, measures the straight-line distance between two vectors in Euclidean space, focusing on their magnitude. It is computed by taking the square root of the sum of the squared differences between corresponding components of the vectors. Lastly, the dot product measures the magnitude of the projection of one vector onto another, calculated as the sum of the products of corresponding components of the vectors. Each of these methods has its own use cases and can be chosen based on the specific requirements of the task at hand.

In step 140, the system determines whether the confidence stitching score is above a first predetermined threshold such as 30%. If the confidence stitching score is above the first predetermined threshold, the system 100 suggests mapping, e.g., stitching, between the physical data and a semantic category in step 150.

In step 160, the system determines if there are multiple categories in the semantic model to which the physical data under consideration maps. If there are multiple categories in the semantic model, the system 100 in step 160 determines whether the multiple categories could be duplicates of one another. If, in step 170, the system 100 determines that there are possible duplicates, the system, in step 175, suggests consolidating the multiple categories in the semantic model.

To determine whether multiple categories are duplicates of one another in step 160, the system 100 can calculate a similarity matrix between the categories in the semantic model while prioritizing relationships within the semantic layer, such as parent child, grandparent child, or sibling relationships in the hierarchical semantic model. If the two categories are siblings, the system 100 can determine that the two categories are more likely duplicates than if the two categories are different levels of the hierarchical semantic model. If semantic assets are too similar, the system 100 can suggest a consolidation action. This way, the system 100 targets groups of categories that represent redundancy or lack of clarity in the semantic model. The consolidation action can include merging similar assets or creating sub-assets with clearer definitions. The system 100 can present these refinement suggestions to the user to accept or reject.

In step 180 and 190, the system 100 creates a notification suggesting stitching, i.e., mapping, between the physical data and the corresponding categories in the semantic model and provides the similarity score.

In step 115, if the confidence stitching score is below the first predetermined threshold, the system 100 identifies the physical data under consideration as not stitched, e.g., mapped, to a semantic category. This identified physical data highlights the gaps in the governance landscape. The system 100, rather than making generic suggestions, in step 115 proposes a new semantic, e.g. semantic, category in line with existing mapping to map to the unstitched physical data. The system 100 can submit the suggested new semantic category as a new creation request in the semantic model and can pre-populate the new category with relevant information such as asset type, description, technical data type, categorization, and/or tags, as described in FIG. 9 below. The LLM embedding 185 identifies the similarity score between the physical data and the newly created semantic category, and the system proceeds to step 180 and 190 described above. The LLM embedding 185 can be the same as the LLM 130.

In step 125, the system 100 can obtain a second threshold which can be specified by the user as described in this application. The system 100 can compare the similarity score to the second threshold and determine if the similarity score is above the threshold. If the similarity score is above the second threshold, the system can automatically accept the mapping in step 135 or can present this course above the second similarity threshold, in step 145, for the user to manually accept or reject. In step 155, the system 100, upon receiving an acceptance of a mapping, can create the required mapping relationship. In step 195, the system 100 can update the datastore 108 storing the mapping, and the newly obtained mappings can be provided in the next operation of the system in step 110.

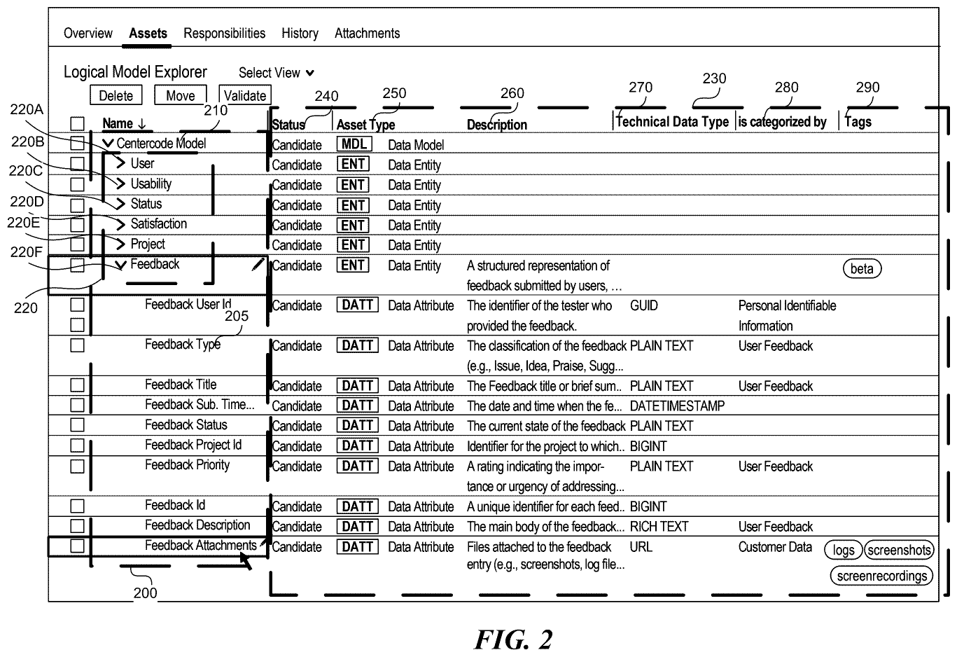

FIG. 2 shows a semantic model. The semantic model 200 can be hierarchical and include multiple levels such as the root level 210 representing the name of the semantic model, as well as a child level 220 representing the subsequent level in the hierarchy including categories such as user 220A, usability 220B, status 220C, satisfaction 220D, project 220E and feedback 220F. Each category in the child level 220 can include subcategories. For example, the feedback 220F category can include subcategories feedback user ID, feedback type, feedback title, etc., as shown in FIG. 2.

The pane 230 shows the metadata including status 240, asset type 250, description 260, technical data type 270, categorization 280, and tags 290 associated with each category (e.g., root level 210, child level 220) in the semantic model 200. For example, the category 205 feedback type has the metadata that it is candidate, that it is a data attribute, and has the description that it provides classification of the feedback such as issue, idea, praise, suggestion, or custom defined type. Further, the category 205 feedback type has the metadata showing which physical data type it corresponds to, such as plaintext, and whether it belongs to category user feedback, personally identifiable information, or customer data. Certain categories such as personal identifiable information are more sensitive than, for example, user feedback or customer data.

More specifically, as also seen in FIG. 2, the category “Feedback” can have the corresponding description stating “a structured representation of feedback submitted by users, customers, or stakeholders in the form of issues, ideas, praise, and discussions.” The category “Feedback User Id” can have the description that states “the identifier of the tester who provided the feedback.” The category “feedback type” can have the description “the classification of the feedback (e.g., issue, idea, praise, suggestion, or custom defined types).” The category feedback title can have the description “the feedback title or brief summary.” The category feedback submission timestamp can have the description “the date and time with the feedback was submitted.” The category “feedback status” can have the description “the current state of the feedback (e.g., open, in progress, resolved, closed, etc.).” The category “feedback project ID” has the description “identifier for the project to which feedback is related.” The category “Feedback Priority” has the description “a rating indicating the importance of or urgency of addressing the feedback (if applicable, often configurable.)” The feedback priority depends on the type of feedback. For example, it is different for issues compared to ideas. The category “Feedback Id” has the description “a unique identifier for each feedback item.” The category “feedback description” has the description “the main body of the feedback describing the issue, idea, or other.” The category “feedback attachment” has the description “files attached to the feedback entry (e.g., screenshots, log files, etc.).”

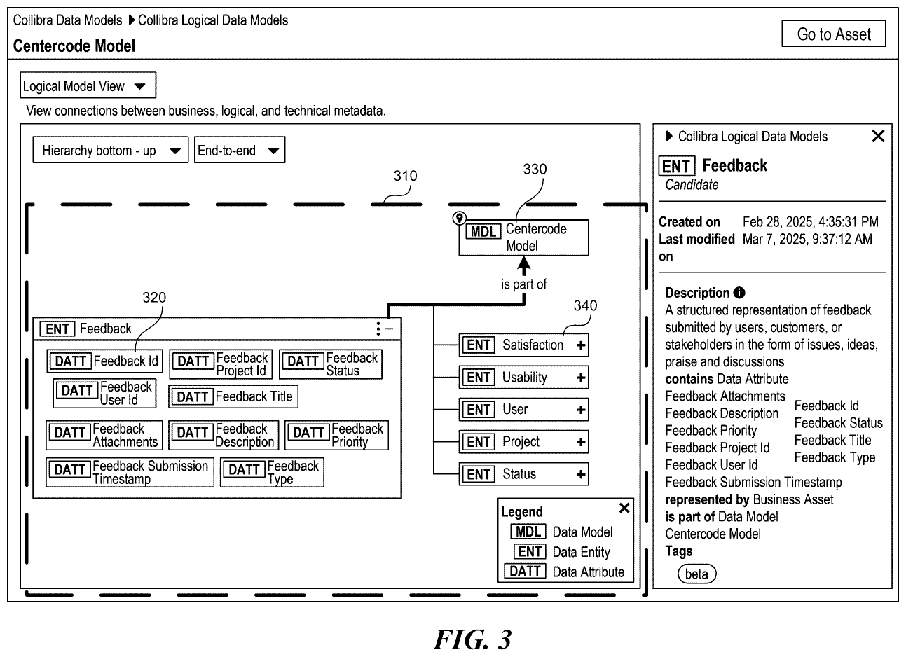

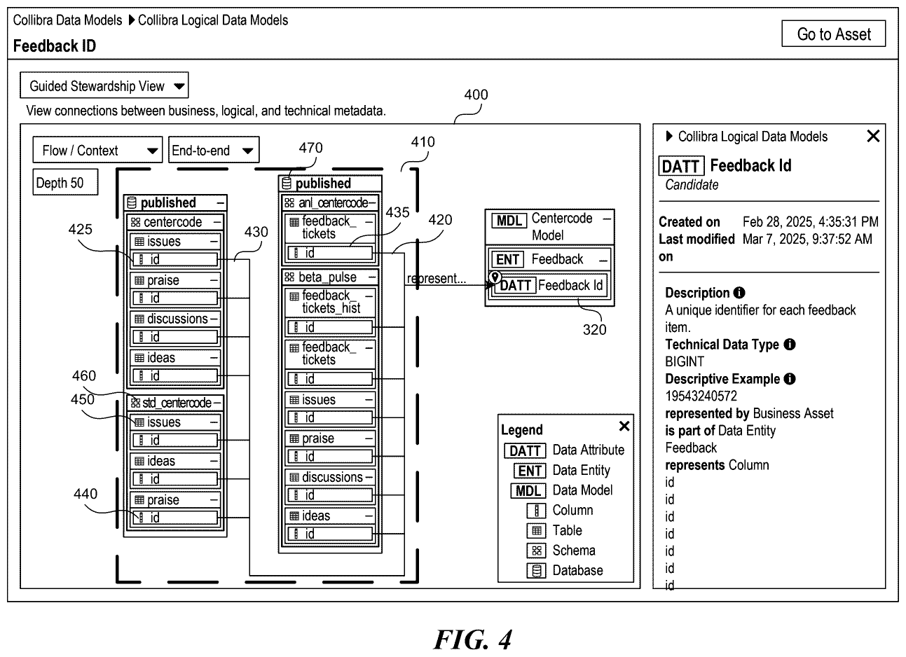

FIG. 3 shows a hierarchical visualization of semantic model categories. The semantic model 200 in FIG. 2 can be represented in the hierarchical visualization 310, where each of the categories 320, 330, 340 (only 3 labeled for brevity) can be selected. After selecting, for example, the category 320 titled “Feedback Id,” the system shows the mapping 400 in FIG. 4 between category 320 “Feedback Id” and physical data.

FIG. 4 shows the mapping 400 between a category in the semantic model and physical data. The category 320 in the semantic model 300 in FIG. 3 is mapped to physical data 410. The connections 420, 430 (only 2 labeled for brevity) show the correspondence between physical data 425, 435, and the category 320. The physical data 425, 435 can stored in columns 440, tables 450, schemas 460, or datastores 470, where the column is a part of table, which is a part of a schema, which is a part of a datastore. The category 320 “Feedback Id” is mapped to physical data 410 across multiple schemas such as centercode, as std_centercode, anl_centercode, and beta_pulse, and across multiple tables.

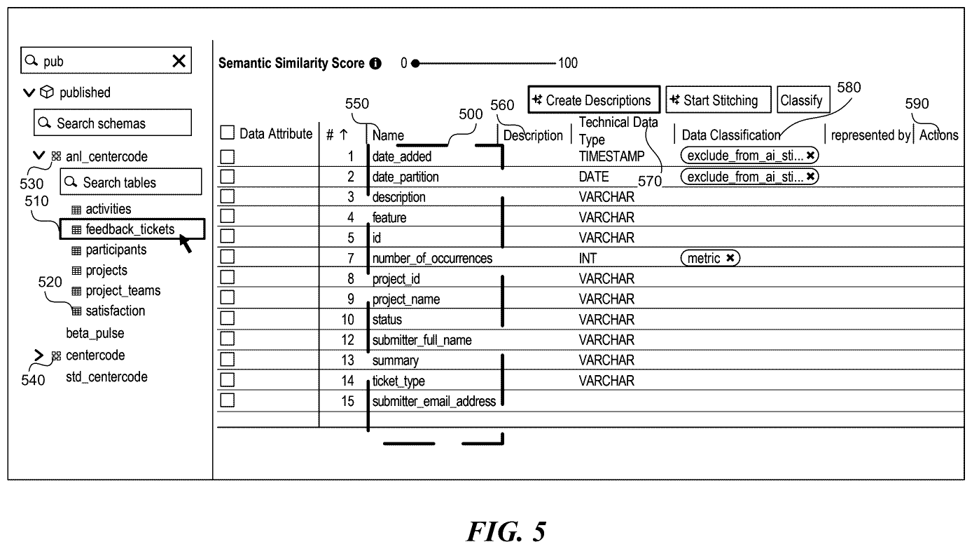

FIG. 5 shows metadata associated with the physical data. The physical data 500 can be stored in tables 510, 520 (only 2 labeled for brevity), which are in turn stored in various schemas 530, 540 (only 2 labeled for brevity). The physical data 500 can include various metadata such as name 550, description 560, technical data type 570, data classification 580, actions 590, etc. The various metadata 550-590 can be provided to the LLM 130 in FIG. 1.

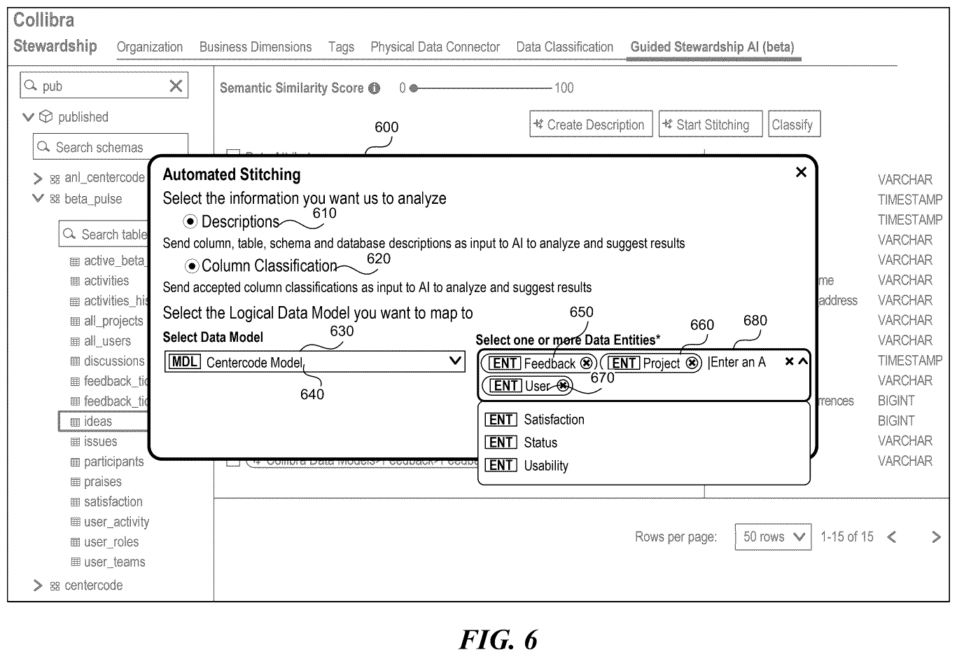

FIG. 6 shows selection of metadata to provide to the LLM 130. The user interface 600 enables a user to select which metadata (e.g., descriptions 610, column classification 620) associated with the physical data to send to the LLM 130 in FIG. 1 when generating the mapping between the physical data and the semantic model. The user can, but does not have to, select descriptions 610 associated with the column, table, schema, and/or datastore associated with the physical data to send to the LLM 130. In addition, the user can, but does not have to, select column classification 620, such as data classification 580 in FIG. 5, to send to the LLM 130.

The user interface element 630 enables the user to select to which semantic model 640 to map the physical data. User interface element 680 enables the user to select which categories 650, 660, 670 in the semantic model 640 to map to the physical data.

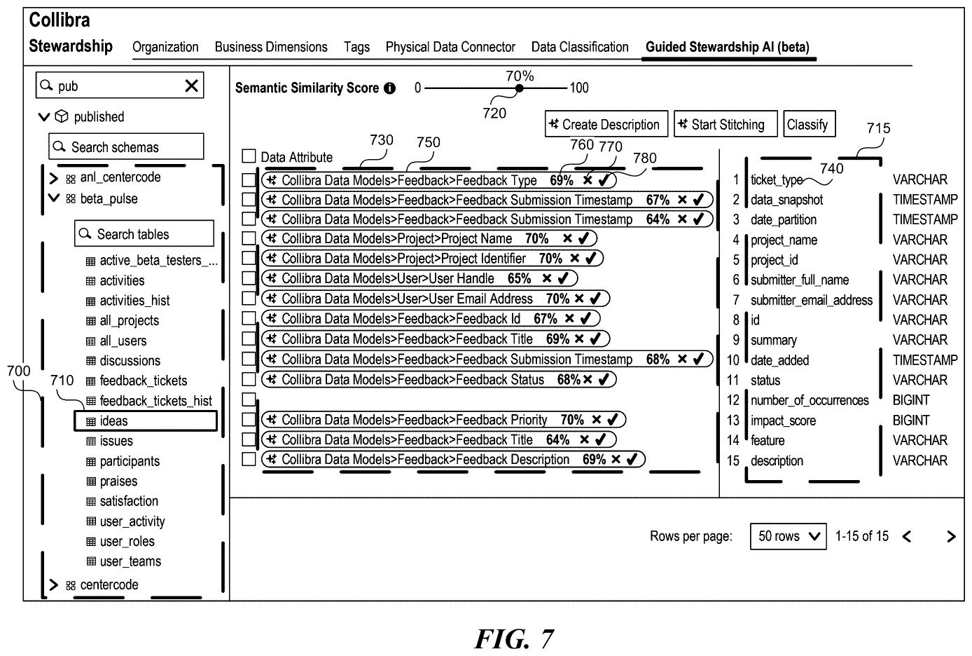

FIG. 7 shows suggested mapping of physical data to categories in the semantic model. The system can receive a selection of physical data 700 to map to the semantic model. The physical data 700 can contain categories, including subcategories, of data 710, 715 each of which needs to be mapped to a category in the semantic model. For example, the physical data 700 can be the database and physical data 710 can be a table, while the physical data 715 can represent columns.

The system can also receive a user input of the semantic similarity score threshold 720. The similarity score threshold 720 indicates that any similarity scores below this threshold should be discarded, and any similarity scores above the threshold can either be automatically accepted or presented to the user to accept or reject.

The system can generate the mapping 730 which indicates how a physical data 740 (only one labeled for brevity) maps to a category 750 (only one labeled for brevity) in the semantic model. The category 750 can be indicated by a path through the hierarchical semantic model starting with the root level category “Collibra data models,” followed by a subcategory “Feedback” and finally the category corresponding to the physical data 740, “Feedback Type.”

The system can present user interface element 760 (only one labeled for brevity) indicating the measure of similarity, e.g., similarity score, between the physical data 740 and the category 750. In addition, the system can represent the user interface element 770 enabling the user to reject the mapping or the user interface element 780 enabling the user to accept the mapping. If the user accepts the mapping, the system stores the mapping and the datastore 108 in FIG. 1.

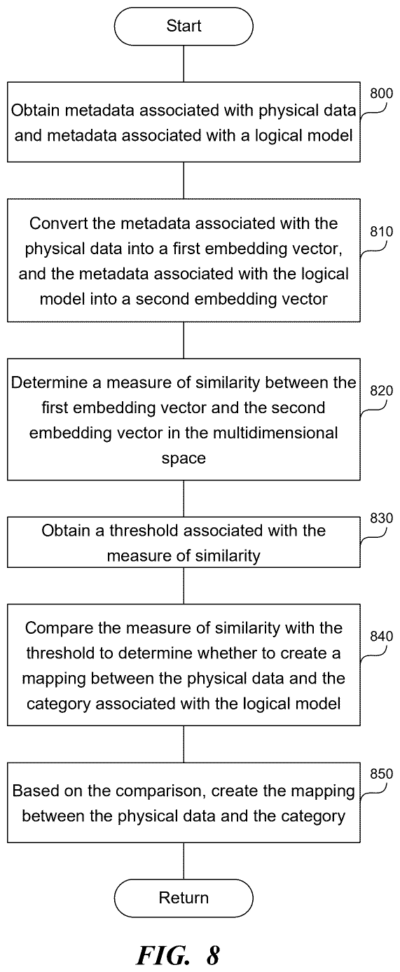

FIG. 8 is a flowchart of a method to create a mapping between physical data and a category in a semantic model. A hardware or software processor executing instructions describing this application can in step 800 obtain metadata associated with physical data and metadata associated with a semantic model. The semantic model can include multiple categories, as described in this application. The metadata associated with physical data indicates a description associated with the physical data, such as a data type including timestamp, date, character, string, integer etc. Further, the metadata associated with the physical data can include accepted classifications associated with the physical data, which can be accepted mappings between the same column names of physical data previously considered, and a category in the semantic model. The metadata associated with the semantic model includes description associated with a category associated with the semantic model and can also include the name of the category.

For example, as can be seen in FIG. 2, the category name “Feedback” can have a description “a structured representation of feedback submitted by users, customers, or stakeholders in the form of issues, ideas, praise and discussions.” The category “Feedback User Id” can have a description “the identifier of the tester who provided the feedback.” The category “Feedback Type” can have the description “the classification of the feedback (e.g., issues, idea, praise, suggestion or custom defined types).” The category “Feedback Title” can have the description “the feedback title or brief summary.” The category “Feedback Submission Timestamp” can have the description “the date and time when the feedback was submitted.” The category “Feedback status” can have description “the current state of the Feedback (e.g., open, in progress, resolved, closed, etc.).” The category “Feedback Project ID” can have the description “identifier for the project to which this Feedback is related.” The category “Feedback Priority” can have the description “a rating indicating the importance or urgency of addressing the feedback (if applicable, often configurable).” The feedback priority depends on the type of feedback (for example, “it is different for issue compared to idea”). The category “Feedback Id” can have description “a unique identifier for each feedback item.” The category “Feedback Description” can have the description “the main body of the feedback describing the issue, idea, or other.” The category “Feedback Attachments” can have the description “files attached to the feedback entry (e.g., screenshots, log files, etc.).”

In step 810, the processor can convert the metadata associated with the physical data into a first embedding vector, and the metadata associated with the semantic model into a second embedding vector. The first embedding vector can be a first numerical vector in a multidimensional space, while the second embedding vector can be a second numerical vector in the multidimensional space.

In step 820, the processor can determine a measure of similarity, e.g., similarity score, between the first embedding vector and the second embedding vector in the multidimensional space, using one of the measures of similarity such as cosine similarity, Euclidean distance, and dot product.

In step 830, the processor can obtain a threshold associated with the measure of similarity, such as 60% or 70%.

In step 840, the processor can compare the measure of similarity with the threshold to determine whether to create a mapping between the physical data and the category associated with the semantic model. For example, in the comparison, the processor can determine whether the measure of similarity exceeds the threshold, and if it does, the processor can automatically create the mapping between physical data in the category of the semantic model. Alternatively, the processor can suggest the mapping to the user, and the user can choose to accept or reject the mapping. If the measure of similarity does not exceed the threshold, the processor can automatically reject the mapping or can choose not to even present the suggestion to the user.

In step 850, based on the comparison, the processor can create the mapping between the physical data and the category.

The processor can compare the measure of similarity with the threshold to determine whether to present the measure of similarity to a user. Upon determining to present the similarity score, the processor can present a suggested mapping to a user, a user interface element allowing acceptance of the suggested mapping, and a user interface element allowing rejection of the suggested mapping. The suggested mapping can include an indication of the physical data associated with the first embedding vector and an indication of the category in the semantic model associated with the second embedding vector. Upon receiving a selection of the user interface element allowing acceptance of the suggested mapping, the processor can map the physical data to the category in the semantic model.

Upon determining not to present the similarity score, the processor can determine a new category in the semantic model corresponding to the physical data and a location of the new category in a hierarchy associated with the semantic model. The processor can suggest a creation of the new category to the user.

The processor can obtain a third metadata associated with a third category associated with the semantic model. The third metadata can include a third description associated with the third category and can also include a name of the third category. The processor can convert the third metadata into a third embedding vector, where the third embedding vector is a third numerical vector in the multidimensional space. The processor can determine a second measure of similarity between the second numerical vector and the third numerical vector and can compare the second measure of similarity with a second threshold. Based on the comparison, the processor can determine whether the third category and the category associated with the semantic model are similar. Upon determining that the third category and the category associated with the semantic model are similar, this processor can suggest performing an action such as merging the first category and the third category or creating a subcategory with differing descriptions.

The processor can obtain a third metadata associated with a third category associated with the semantic model. The third metadata can include a third description associated with the third category and can also include the name associated with the third category. The processor can convert the third metadata into a third embedding vector, where the third embedding vector is a third numerical vector in the multidimensional space. The processor can determine a second measure of similarity between the first numerical vector and the third numerical vector and can compare the second measure of similarity with the threshold. Based on the comparison, the processor can determine whether the first numerical vector and the third numerical vector are similar. Upon determining that the first numerical vector and the third numerical vector are similar, the processor can determine that the first category and the third category are similar. Upon determining the first category and the third category are similar, the processor can suggest performing an action, such as merging the first category and the third category or creating a subcategory with differing descriptions.

The processor can obtain third metadata associated with a third physical data. The third metadata associated with the third physical data indicates a description associated with the third physical data. The third metadata can also include accepted classifications associated with the physical data, which can be accepted mappings between the same column names in previously considered physical data and semantic models. The processor can convert the third metadata associated with the third physical data into a third embedding vector, where the third embedding vector is a third numerical vector in the multidimensional space. The processor can determine a second measure of similarity between the first embedding vector and the third embedding vector in the multidimensional space. The processor can obtain a second threshold, such as 70%, associated with the measure of similarity. The processor can compare the second measure of similarity with the second threshold to determine whether the physical data and the third physical data are similar. Upon determining that the third physical data and the physical data are similar, the processor can obtain the category in the semantic model to which the physical data is mapped. The processor can consider the category when determining a mapping between the third physical data and the semantic model. To consider the category, for example, the processor can provide the third category as input to the LLM 130 in FIG. 1. Further, the processor can obtain multiple categories for physical data similar to the physical data under consideration and provide those multiple categories as the only categories for the LLM 130 to consider.

The processor can obtain metadata associated with physical data and metadata associated with a semantic model. The metadata associated with the physical data can include a first data type, such as the technical data type 270 in FIG. 2. The metadata associated with the category associated with the semantic model can include a second data type, such as the technical data type 570 in FIG. 5. The processor can determine whether the first data type and the second data type match, such as determining whether the data types 270, 570 are both numerical types, text types, data types, etc., or whether they are exactly the same type such as timestamp, date, integer, text, URL, rich text, etc. Upon determining that the first data type and the second data type do not match, the processor can avoid determining the mapping between the physical data and the category by, for example, not providing that category to the LLM 130 in FIG. 1 to compute the embedding vectors.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others. Unlike discriminative models, generative models are distinguished by their ability to create new, synthetic data that closely resembles the training data. In contrast, discriminative models focus on predicting labels for given inputs.

DNNs are often used as ML-based models for modeling complex behaviors (e.g., human language, image recognition, object classification) in order to improve the accuracy of outputs (e.g., more accurate predictions) for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., to minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses large language models (LLMs).

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 9 is a block diagram 900 of an example transformer 912. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as RNN-based language models.

The transformer 912 includes an encoder 908 (which can include one or more encoder layers/blocks connected in series) and a decoder 910 (which can include one or more decoder layers/blocks connected in series). Generally, the encoder 908 and the decoder 910 each include multiple neural network layers, at least one of which can be a self-attention layer. The parameters of the neural network layers can be referred to as the parameters of the language model.

The transformer 912 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 912 is trained to perform certain functions on input formats other than natural language input. For example, the input can include objects, images, audio content, or video content, or a combination thereof.

The transformer 912 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 9 illustrates an example of how the transformer 912 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 9, a short sequence of tokens 902 corresponding to the input text is illustrated as input to the transformer 912. Tokenization of the text sequence into the tokens 902 can be performed by some pre-processing tokenization modules such as, for example, a byte-pair encoding tokenizer (the “pre” referring to the tokenization occurring prior to the processing of the tokenized input by the LLM), which is not shown in FIG. 9 for brevity. In general, the token sequence that is inputted to the transformer 912 can be of any length up to a maximum length defined based on the dimensions of the transformer 912. Each token 902 in the token sequence is converted into an embedding vector 906 (also referred to as “embedding 906”).

An embedding 906 is a learned numerical representation (such as, for example, a vector) of a token that captures some semantic meaning of the text segment represented by the token 902. The embedding 906 represents the text segment corresponding to the token 902 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 906 corresponding to the “write” token will be closer to another embedding corresponding to the “jot down” token in the vector space as compared to the distance between the embedding 906 corresponding to the “write” token and another embedding corresponding to the “summary” token.

The vector space can be defined by the dimensions and values of the embedding vectors. Various techniques can be used to convert a token 902 to an embedding 906. For example, another trained ML model can be used to convert the token 902 into an embedding 906. In particular, another trained ML model can be used to convert the token 902 into an embedding 906 in a way that encodes additional information into the embedding 906 (e.g., a trained ML model can encode positional information about the position of the token 902 in the text sequence into the embedding 906). In some implementations, the numerical value of the token 902 can be used to look up the corresponding embedding in an embedding matrix 904, which can be learned during training of the transformer 912.

The generated embeddings 906 are input into the encoder 908. The encoder 908 serves to encode the embeddings 906 into feature vectors 914 that represent the latent features of the embeddings 906. The encoder 908 can encode positional information (i.e., information about the sequence of the input) in the feature vectors 914. The feature vectors 914 can have very high dimensionality (e.g., on the order of thousands or tens of thousands), with each element in a feature vector 914 corresponding to a respective feature. The numerical weight of each element in a feature vector 914 represents the importance of the corresponding feature. The space of all possible feature vectors 914 that can be generated by the encoder 908 can be referred to as a latent space or feature space.

Conceptually, the decoder 910 is designed to map the features represented by the feature vectors 914 into meaningful output, which can depend on the task that was assigned to the transformer 912. For example, if the transformer 912 is used for a translation task, the decoder 910 can map the feature vectors 914 into text output in a target language different from the language of the original tokens 902. Generally, in a generative language model, the decoder 910 serves to decode the feature vectors 914 into a sequence of tokens. The decoder 910 can generate output tokens 916 one by one. Each output token 916 can be fed back as input to the decoder 910 in order to generate the next output token 916. By feeding back the generated output and applying self-attention, the decoder 910 can generate a sequence of output tokens 916 that has sequential meaning (e.g., the resulting output text sequence is understandable as a sentence and obeys grammatical rules). The decoder 910 can generate output tokens 916 until a special [EOT] token (indicating the end of the text) is generated. The resulting sequence of output tokens 916 can then be converted to a text sequence in post-processing. For example, each output token 916 can be an integer number that corresponds to a vocabulary index. By looking up the text segment using the vocabulary index, the text segment corresponding to each output token 916 can be retrieved, the text segments can be concatenated together, and the final output text sequence can be obtained.

In some implementations, the input provided to the transformer 912 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Computer System

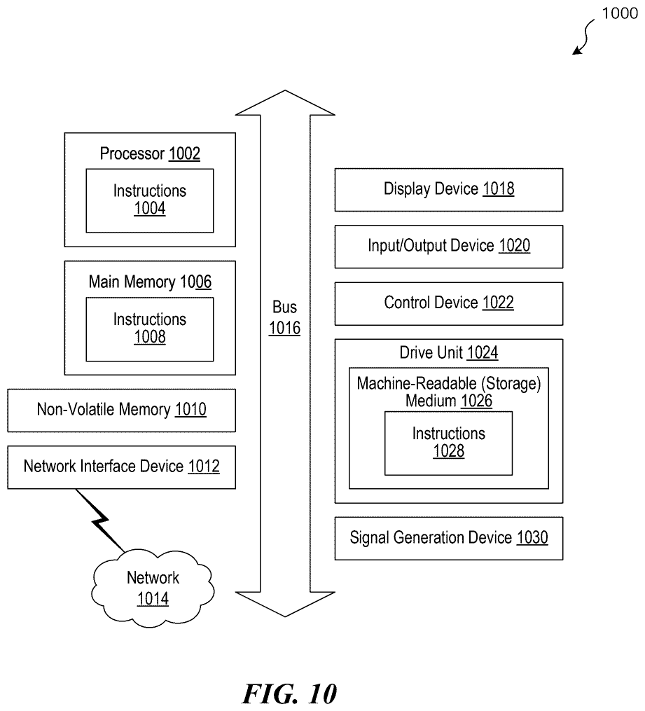

FIG. 10 is a block diagram that illustrates an example of a computer system 1000 in which at least some operations described herein can be implemented. As shown, the computer system 1000 can include: one or more processors 1002, main memory 1006, non-volatile memory 1010, a network interface device 1012, a video display device 1018, an input/output device 1020, a control device 1022 (e.g., keyboard and pointing device), a drive unit 1024 that includes a machine-readable (storage) medium 1026, and a signal generation device 1030 that are communicatively connected to a bus 1016. The bus 1016 represents one or more physical buses and/or point-to-point connections that are connected by appropriate bridges, adapters, or controllers. Various common components (e.g., cache memory) are omitted from FIG. 10 for brevity. Instead, the computer system 1000 is intended to illustrate a hardware device on which components illustrated or described relative to the examples of the Figures and any other components described in this specification can be implemented.

The computer system 1000 can take any suitable physical form. For example, the computing system 1000 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1000. In some implementations, the computer system 1000 can be an embedded computer system, a system-on-chip (SOC), a single-board computer system (SBC), or a distributed system such as a mesh of computer systems, or it can include one or more cloud components in one or more networks. Where appropriate, one or more computer systems 1000 can perform operations in real time, in near real time, or in batch mode.

The network interface device 1012 enables the computing system 1000 to mediate data in a network 1014 with an entity that is external to the computing system 1000 through any communication protocol supported by the computing system 1000 and the external entity. Examples of the network interface device 1012 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1006, non-volatile memory 1010, machine-readable medium 1026) can be local, remote, or distributed. Although shown as a single medium, the machine-readable medium 1026 can include multiple media (e.g., a centralized/distributed database and/or associated caches and servers) that store one or more sets of instructions 1028. The machine-readable medium 1026 can include any medium that is capable of storing, encoding, or carrying a set of instructions for execution by the computing system 1000. The machine-readable medium 1026 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1010, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memory and storage devices in computing device(s). When read and executed by the processor 1002, the instruction(s) cause the computing system 1000 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, semantic, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium comprising instructions recorded thereon, wherein the instructions, when executed by at least one data processor of a system, cause the system to:
obtain metadata associated with physical data and metadata associated with a semantic model,
wherein the semantic model includes multiple categories,
wherein the metadata associated with physical data indicates a description associated with the physical data;
wherein the metadata associated with the semantic model includes a description associated with a category among the multiple categories associated with the semantic model;
convert the metadata associated with the physical data into a first embedding vector, and the metadata associated with the category among the multiple categories into a second embedding vector,
wherein the first embedding vector is a first numerical vector in a multidimensional space, and
wherein the second embedding vector is a second numerical vector in the multidimensional space;
determine a measure of similarity between the first embedding vector and the second embedding vector in the multidimensional space;
obtain a threshold associated with the measure of similarity;
compare the measure of similarity with the threshold to determine whether to present the measure of similarity to a user;
upon determining to present the measure of similarity, present a suggested mapping to a user, a user interface element allowing acceptance of the suggested mapping, and a user interface element allowing rejection of the suggested mapping, wherein the suggested mapping includes an indication of the physical data associated with the first embedding vector and an indication of the category in the semantic model associated with the second embedding vector; and
upon receiving a selection of the user interface element allowing acceptance of the suggested mapping, map the physical data to the category in the semantic model.

2. The non-transitory, computer-readable storage medium of claim 1, comprising instructions to:
obtain third metadata associated with a third physical data,
wherein the third metadata associated with the third physical data indicates a description associated with the third physical data;
convert the third metadata associated with the third physical data into a third embedding vector,
wherein the third embedding vector is a third numerical vector in the multidimensional space;
determine a second measure of similarity between the first embedding vector and the third embedding vector in the multidimensional space;
obtain a second threshold associated with the measure of similarity;
compare the second measure of similarity with the second threshold, to determine whether the physical data and the third physical data are similar;
upon determining that the third physical data and the physical data are similar, obtain the category in the semantic model to which the physical data is mapped; and
consider the category when determining a mapping between the third physical data and the semantic model.

3. The non-transitory, computer-readable storage medium of claim 1, comprising instructions to:
upon determining not to present the measure of similarity, determine a new category in the semantic model corresponding to the physical data, and a location of the new category in a hierarchy associated with the semantic model; and
suggest a creation of the new category to the user.

4. The non-transitory, computer-readable storage medium of claim 1, comprising instructions to:
obtain a third metadata associated with a third category associated with the semantic model,
wherein the third metadata includes a third description associated with the third category;
convert the third metadata into a third embedding vector,
wherein the third embedding vector is a third numerical vector in the multidimensional space;
determine a second measure of similarity between the second numerical vector and the third numerical vector;
compare the second measure of similarity with a second threshold;
based on the comparison, determine whether the third category and the category associated with the semantic model are similar; and
upon determining that the third category and the category associated with the semantic model are similar, suggest performing an action,
wherein the action includes merging the category and the third category or creating a subcategory with differing descriptions.

5. The non-transitory, computer-readable storage medium of claim 1, comprising instructions to:
obtain a third metadata associated with a third category associated with the semantic model,
wherein the third metadata includes a third description associated with the third category;
convert the third metadata into a third embedding vector,
wherein the third embedding vector is a third numerical vector in the multidimensional space;
determine a second measure of similarity between the first numerical vector and the third numerical vector;
compare the second measure of similarity with the threshold;
based on the comparison, determine whether the first numerical vector and the third numerical vector are similar; and
upon determining that the first numerical vector and the third numerical vector are similar, determine that the category and the third category are similar;
upon determining that the category and the third category are similar, suggest performing an action,
wherein the action includes merging the category and the third category or creating a subcategory with differing descriptions.

6. The non-transitory, computer-readable storage medium of claim 1, comprising instructions to:
obtain metadata associated with physical data and metadata associated with a semantic model,
wherein the metadata associated with the physical data includes a first data type, and
wherein the metadata associated with the category associated with the semantic model includes a second data type;
determine whether the first data type and the second data type match; and
upon determining that the first data type and the second data type do not match, avoid determining a mapping between the physical data and the category.

7. A method comprising:
obtaining metadata associated with physical data and metadata associated with a semantic model,
wherein the semantic model includes multiple categories;
converting the metadata associated with the physical data into a first embedding vector, and the metadata associated with a category among the multiple categories into a second embedding vector,
wherein the first embedding vector is a first numerical vector in a multidimensional space, and
wherein the second embedding vector is a second numerical vector in the multidimensional space;
determining a measure of similarity between the first embedding vector and the second embedding vector in the multidimensional space;
obtaining a threshold associated with the measure of similarity;
comparing the measure of similarity with the threshold to determine whether to create a mapping between the physical data and the category associated with the semantic model; and
based on the comparison, creating the mapping between the physical data and the category.

8. The method of claim 7, comprising:
comparing the measure of similarity with the threshold to determine whether to present the measure of similarity to a user;
upon determining to present the measure of similarity, presenting to the user a suggested mapping, a user interface element allowing acceptance of the suggested mapping, and a user interface element allowing rejection of the suggested mapping, wherein the suggested mapping includes an indication of the physical data associated with the first embedding vector and an indication of the category in the semantic model associated with the second embedding vector; and
upon receiving a selection of the user interface element allowing acceptance of the suggested mapping, mapping the physical data to the category in the semantic model.

9. The method of claim 7, comprising:
upon determining not to present the measure of similarity, determining a new category in the semantic model corresponding to the physical data, and a location of the new category in a hierarchy associated with the semantic model; and
suggesting a creation of the new category.

10. The method of claim 7, comprising:
obtaining a third metadata associated with a third category associated with the semantic model,
wherein the third metadata includes a third description associated with the third category;
converting the third metadata into a third embedding vector,
wherein the third embedding vector is a third numerical vector in the multidimensional space;
determining a second measure of similarity between the second numerical vector and the third numerical vector;
comparing the second measure of similarity with a second threshold;
based on the comparison, determining whether the third category and the category associated with the semantic model are similar; and
upon determining that the third category and the category associated with the semantic model are similar, suggesting performing an action,
wherein the action includes merging the category and the third category or creating a subcategory with differing descriptions.

11. The method of claim 7, comprising:
obtaining a third metadata associated with a third category associated with the semantic model,
wherein the third metadata includes a third description associated with the third category;
converting the third metadata into a third embedding vector,
wherein the third embedding vector is a third numerical vector in the multidimensional space;
determining a second measure of similarity between the first numerical vector and the third numerical vector;
comparing the second measure of similarity with the threshold;
based on the comparison, determining whether the first numerical vector and the third numerical vector are similar; and
upon determining that the first numerical vector and the third numerical vector are similar, determining that the category and the third category are similar; and
upon determining the category and the third category are similar, suggesting performing an action,
wherein the action includes merging the category and the third category or creating a subcategory with differing descriptions.

12. The method of claim 7, comprising:
obtaining a third metadata associated with a third physical data,
wherein the third metadata associated with the third physical data indicates a description associated with the third physical data;
converting the third metadata associated with the third physical data into a third embedding vector,
wherein the third embedding vector is a third numerical vector in the multidimensional space;
determining a second measure of similarity between the first embedding vector and the third embedding vector in the multidimensional space;
obtaining a second threshold associated with the measure of similarity;
comparing the second measure of similarity with the second threshold, to determine whether the physical data and the third physical data are similar;
upon determining that the third physical data and the physical data are similar, obtaining the category in the semantic model to which the physical data is mapped; and
considering the category when determining a mapping between the third physical data and the semantic model.

13. The method of claim 7, comprising:
obtaining the metadata associated with the physical data and the metadata associated with the semantic model,
wherein the metadata associated with the physical data includes a first data type, and
wherein the metadata associated with the category associated with the semantic model includes a second data type;
determining whether the first data type and the second data type match; and
upon determining that the first data type and the second data type do not match, avoiding determining the mapping between the physical data and the category.

14. A system comprising:
at least one hardware processor; and
at least one non-transitory memory storing instructions, which, when executed by the at least one hardware processor, cause the system to:
obtain metadata associated with physical data and metadata associated with a semantic model,
wherein the semantic model includes multiple categories;
convert the metadata associated with the physical data into a first embedding vector, and the metadata associated with a category among the multiple categories into a second embedding vector,
wherein the first embedding vector is a first numerical vector in a multidimensional space, and
wherein the second embedding vector is a second numerical vector in the multidimensional space;
determine a measure of similarity between the first embedding vector and the second embedding vector in the multidimensional space;
obtain a threshold associated with the measure of similarity;
compare the measure of similarity with the threshold to determine whether to create a mapping between the physical data and the category associated with the semantic model; and
based on the comparison, create the mapping between the physical data and the category.

15. The system of claim 14, comprising instructions to:
compare the measure of similarity with the threshold to determine whether to present the measure of similarity to a user;
upon determining to present the measure of similarity, present to a user a suggested mapping, a user interface element allowing acceptance of the suggested mapping, and a user interface element allowing rejection of the suggested mapping, wherein the suggested mapping includes an indication of the physical data associated with the first embedding vector and an indication of the category in the semantic model associated with the second embedding vector; and
upon receiving a selection of the user interface element allowing acceptance of the suggested mapping, map the physical data to the category in the semantic model.

16. The system of claim 14, comprising instructions to:
upon determining not to present the measure of similarity, determine a new category in the semantic model corresponding to the physical data, and a location of the new category in a hierarchy associated with the semantic model; and
suggest a creation of the new category.

17. The system of claim 14, comprising instructions to:
obtain a third metadata associated with a third category associated with the semantic model,
wherein the third metadata includes a third description associated with the third category;
convert the third metadata into a third embedding vector,
wherein the third embedding vector is a third numerical vector in the multidimensional space;
determine a second measure of similarity between the second numerical vector and the third numerical vector;
compare the second measure of similarity with a second threshold;
based on the comparison, determine whether the third category and the category associated with the semantic model are similar; and
upon determining that the third category and the category associated with the semantic model are similar, suggest performing an action,
wherein the action includes merging the category and the third category or creating a subcategory with differing descriptions.

18. The system of claim 14, comprising instructions to:
obtain a third metadata associated with a third category associated with the semantic model,
wherein the third metadata includes a third description associated with the third category;
convert the third metadata into a third embedding vector,
wherein the third embedding vector is a third numerical vector in the multidimensional space;
determine a second measure of similarity between the first numerical vector and the third numerical vector;
compare the second measure of similarity with the threshold;
based on the comparison, determine whether the first numerical vector and the third numerical vector are similar; and
upon determining that the first numerical vector and the third numerical vector are similar, determine that the category and the third category are similar;
upon determining the category and the third category are similar, suggest performing an action,
wherein the action includes merging the category and the third category or creating a subcategory with differing descriptions.

19. The system of claim 14, comprising instructions to:
obtain third metadata associated with a third physical data,
wherein the third metadata associated with the third physical data indicates a description associated with the third physical data;
convert the third metadata associated with the third physical data into a third embedding vector,
wherein the third embedding vector is a third numerical vector in the multidimensional space;
determine a second measure of similarity between the first embedding vector and the third embedding vector in the multidimensional space;
obtain a second threshold associated with the measure of similarity;
compare the second measure of similarity with the second threshold, to determine whether the physical data and the third physical data are similar;
upon determining that the third physical data and the physical data are similar, obtain the category in the semantic model to which the physical data is mapped; and
consider the category when determining a mapping between the third physical data and the semantic model.

20. The system of claim 14, comprising instructions to:
obtain the metadata associated with the physical data and the metadata associated with the semantic model,
wherein the metadata associated with the physical data includes a first data type, and
wherein the metadata associated with the category associated with the semantic model includes a second data type;
determine whether the first data type and the second data type match;
upon determining that the first data type and the second data type do not match, avoid determining the mapping between the physical data and the category.
